(19) United States
(12) Patent Application Publication
(10) Pub. No.: US 2006/0255258 A1
(43) Pub. Date: Nov. 16, 2006

(54) Chromatographic and mass spectral date analysis

(76) Inventors: Yongdong Wang, Wilton, CT (US); Ming Gu, Yardley, PA (US)

Correspondence Address: David Aker, 23 Southern Road, Hartsdale, NY, 10530, US

(21) Appl. No.: 11/402,238

(22) Filed: Apr. 10, 2006

Related U.S. Application Data
(60) Provisional application No. 60/670,182, filed on Apr. 11, 2005.
(60) Provisional application No. 60/685,129, filed on May 29, 2005.

(51) Int. Cl. B01D 59/44

(52) U.S. Cl. 250/282

(57) ABSTRACT

Apparatus, methods, and computer readable media having computer code for calibrating chromatograms to achieve chromatographic peak shape correction, noise filtering, peak detection, retention time determination, baseline correction, and peak area integration. A method for processing a chromatogram, comprises obtaining at least one actual chromatographic peak shape function from one of an internal standard, an external standard, or an analyte represented in the chromatogram; performing chromatographic peak detection using known peak shape functions with regression analysis; reporting regression coefficients from the regression analysis as one of peak area and peak location; and constructing a calibration curve to relate peak area to known concentrations in the chromatogram. A method for constructing an extracted ion chromatogram, comprises calibrating a low resolution mass spectrometer for both mass and peak shape in profile mode; performing mass spectral peak analysis and reporting both mass locations and integrated peak areas; specifying a mass defect window of interest; summing up all detected peaks with mass defects falling within the specified mass defect window to derive summed intensities; and plotting the summed intensities against time to generate a mass defect filtered chromatogram.

This application claims priority from U.S. provisional application Ser. Nos. 60/670,182 filed on Apr. 11, 2005 and 60/685,129 filed on May 29, 2005. The entire teachings of these applications are hereby incorporated by reference, in their entireties.

### RELATED APPLICATIONS

The following patent applications are related to this application. The entire teachings of these patent applications are hereby incorporated herein by reference, in their entireties.

U.S. Ser. No. 10/689,313 filed on Oct. 20, 2003, and issued as U.S. Pat. No. 6,983,213 and International Patent PCT/US04/034618 filed on Oct. 20, 2004 which claims priority therefrom and designates the United States of America as an elected state.

U.S. Provisional patent applications 60/466,010; 60/466,011 and 60/466,012 all filed on Apr. 28, 2003, and International Patent Applications PCT/US04/013096 and PCT/US04/013097 both filed on Apr. 28, 2004 and both designating the United States of America as an elected state.

U.S. Provisional patent application Ser. No. 60/623,114 filed on Oct. 28, 2004 (Attorney Docket Number CE-005US(#1)) and International Patent Application PCT/US2005/039186 filed on Oct. 28, 2005.

### BACKGROUND OF THE INVENTION

1. Field of the Invention

The present invention relates to apparatus, methods, and computer readable media having computer code for calibrating chromatograms to achieve chromatographic peak shape correction, noise filtering, peak detection, retention time determination, baseline correction, and peak area integration.

It also relates to apparatus, methods and computer readable media having computer code for quantitative or qualitative analysis using profile mode mass spectral data, acquired through either full mass spectral scanning mode or Selective Ion Monitoring (SIM) mode.

It also relates to apparatus, methods and computer readable media having computer code for generating simplified and accurate ion chromatograms from a collection of time-dependent mass spectral scans such as in GC/MS or LC/MS experiments.

2. Background Art

Calibration and Processing of Chromatographic Data

As well established methods, liquid and gas chromatograph coupled with mass spectrometry (LC/MS or GC/MS) have been widely used as the primary tool for the quantitation of pharmaceutical molecules in all stages of drug development including drug discovery, lead optimization, clinical trials, and manufacturing of drug products. In particular, a majority of quantitation work focuses on the evaluation of pharmacokinetic (PK) properties of drug candidates in early-stage drug discovery to provide critical information to decide if the evaluated compounds should go for further lead optimization. A tremendous amount of cost saving can be achieved by preventing less desirable drug candidates from entering the development pipelines.

The quantitative analysis by LC/MS for a small drug molecule involves three processes: sample preparation, LC/MS/MS method development, and data processing and report generating.

Two types of samples need to be prepared for a given quantitation assay. They are calibration standard samples and biological study samples. The typical calibration standards are the mixture of an analyte and a corresponding internal standard. Internal calibration is the most commonly used method in LC/MS/MS quantitation. This is because the quantitation process is complicated and involves many steps. From initial sample preparation to final ion detection, the concentration of the samples can be changed due to sample dilution, sample transferring, sample injection, sample degradation, ion source fluctuation, and mass spectrometer drift. Internal calibration is recognized as the effective way to compensate for these signal variations and should be introduced into both calibration standards and study samples as early as possible to minimize any possible errors. The calibration standards should have sufficient concentration coverage for the analyte and are made in duplicate or triplicate aliquots for accurate quantitation.

Another type of sample, biological samples, often comes from test animals. For example, for PK study, the drug molecules are usually administrated into the test animals from which plasma or other body fluid or body tissues are taken for the determination of the concentration of the molecules. Prior to LC/MS analysis, these drug containing samples need to be treated to extract the drug molecules from the complex biological matrix by solid phase extraction, or liquid-liquid extraction, or protein precipitation.

The goal of method development is to obtain optimal LC and MS/MS conditions to achieve maximum sensitivity and the highest throughput for an assay. It is important to know that, even though mass spectrometry offers great selectivity, the separation power provided by chromatography is still very valuable for quantitation. It helps to remove biological matrix and concentrate the sample on a LC column in order to achieve better detection limits. LC can be run either under isocratic or gradient conditions. The former delivers the same solvent at all times and has limited separation, while the latter provides different solvent composition during the LC run and is considered to be more effective in removal of biological matrices and in separation. For the quantitation of small molecules, a mass spectrometer serves as a highly selective and sensitive detector.

Basic components of the mass spectrometer are described in FIG. 1, consisting of an ionization source 24, mass analyzer 26, and a detector 28. Electrospray ionization (ESI) and atmospheric pressure chemical ionization (APCI) are generally used for LC/MS applications whereas electron impact (EI) and chemical ionization (CI) are typically used for GC/MS applications. Matrix assisted laser desorption ionization (MALDI) is another ionization method that is not associated with any one separation technique and is mostly used for the analysis of large molecules such as peptides and proteins. The mass analyzer, a key component of the mass spectrometer, plays an essential role in the mass accuracy, mass resolution, dynamic range, sensitivity, and scanning functions. Quadrupole mass filter and quadrupole ion trap are the preferred choice for quantitation and structural elucidation respectively, while time of flight (TOF) with a reflectron, magnetic sector, Fourier transformation mass spectrometry (FTMS), and other hybrid mass analyzers such as qTOF and linear ion trap/FTMS offer a great deal more in mass resolution etc. at a higher cost.

A detailed description of FIG. 1, FIG. 2 and FIG. 3 may be found in the abovementioned International Patent Application PCTIUS04/013097, filed on Apr. 28, 2004. Note that the system of FIG. 1 may not need the vacuum system, as is the case for ion mobility spectrometry (IMS). In FIG. 2 and FIG. 3, the separation process 12 and/or 64 may also be an ion mobility separation to result in a time-dependent signal typically called a plasmagram instead of chromatogram.

As mentioned above, the popular mass spectrometers for quantitation purposes are quadrupole mass analyzers which can have a single stage quadrupole (SSQ) or a triple stage quadrupole (TSQ). This type of mass spectrometers has a great dynamic range, excellent selectivity, and sensitivity, and is therefore ideal for quantitative analysis. The quadrupole mass analyzer can be scanned to obtain a full mass spectrum or to select individual precursor ions or fragment ions. A TSQ instrument can also be operated in a mode to allow for all the ions to pass through or to induce the fragmentation of ions when collision gas is introduced. Because of the available scanning modes on both SSQ and TSQ, many scanning combinations can be used for quantitative analysis. Recently introduced fast scanning ion traps can not only perform what is possible on SSQ but also part of what TSQ is known for.

Single ion monitoring (SIM) can be performed in a SSQ or a TSQ with one mass analyzer allowing all the ions to pass through. SIM usually scans for molecular ions of an analyte across a very narrow range that is approximately IDa wide. The scanning range can be increased for sensitivity at the risk of detecting ions other than the molecular ions of interest. This scanning mode is usually used in LC/MS and GC/MS applications. When a molecular ion does not produce abundant fragments, this may be the only available choice where the selectivity and sensitivity needs to be carefully balanced.

Multiple reaction monitoring (MRM) or single ion reaction monitoring (SRM) are basically the same operation. They need to be performed on a TSQ instrument. In this scanning mode, the precursor ions selected by the first quadrupole pass through the second quadrupole where collision induced dissociation takes place. The precursor ions traveling with certain kinetic energy collide with a stationary gas phase, usually Argon gas, to fragment into many different product ions. These product ions continue to travel to the third quadrupole where one of the fragments will be selected and used for analysis. This process -from the selection of precursor ions to its fragmentation to the selection of product ions is called a transition. This two-step selection is the reason why TSQ instruments are associated with great selectivity. Typically to analyze one compound, two different transitions are measured. One transition is for the analyte and the other is for the internal standard. During an LC/MS/MS run, the two transitions are alternatively scanned at a very fast scanning rate with about 0.01-0.1 second dwell time for each transition. Mass spectral signal is acquired as integrated ion intensity in a given mass window of typically IDa in size, while chromatographic peaks are used for the determination of analyte concentrations.

Sometimes quantitative analysis also is conducted in full MS scan mode. When the identity of the molecules to be quantified is unknown or simultaneous quantitation of a complex mixture is required, a full scan GC/MS or LC/MS will be the method of choice. The quantitation in this case depends on the integration of various chromatographic peaks from extracted ion chromatograms.

Recent instrument advances allow MRM to be perfonned in high mass resolution modes without, by comparison, significant ion loss. This is available in the Thermo Electron Quantum series, a TSQ-type instrument. It has been shown that quantitation at higher resolution conditions improves selectivity, signal to noise ratio, and the limit of quantitation (LOQ).

Two special scan events available in TSQ are neutral loss and precursor scanning modes. Neutral loss scanning is implemented by scanning both Q1 and Q3 at the same time with a mass offset equal to the mass of the lost neutral.

The final step of the quantitation is used to integrate the peak areas of the analyte and the internal standard, to establish a calibration curve, and to calculate the unknown concentration of an analyte. The key to successful data processing is to have quick and accurate peak integration procedures. While most commercial instrument vendors offer automated procedures to speed up the data processing, these automation packages have not been widely used, due to the challenges posed by low intensity peaks, asymmetric peak shapes, or high and varying backgrounds and/or baselines. As a result, most end users need to go through a manual and tedious data processing phase as part of the overall method development process. First of all, one needs to choose a data file that has a reasonable peak to tune for the optimized peak integration parameters, which will apply to all the data files for peak integration. Second, manual checking of each peak is required to ensure all the peaks are properly integrated. In the case of bad integration, one needs to perform a manual peak integration and/or baseline removal. Thirdly, since a calibration curve is made up of many calibration standards at different concentrations, it is a common practice to drop out any calibration standards that do not conform to the calibration curve. This is another manual process.

Mass Spectral Data Processing for Quantitative and Qualitative Analysis

The past 100 years have witnessed tremendous strides made on the MS instrumentation with many different flavors of instruments designed and built for high throughput, high resolution, and high sensitivity work. The instrumentation has been developed a stage where single ion detection can be routinely accomplished on most commercial MS systems with unit mass resolution allowing for the observation of ion fragments coming from different isotopes. In stark contrast to the sophistication in hardware, very little has been done to systematically and effectively analyze the massive amount of MS data generated by modem MS instrumentation.

On a typical mass spectrometer, the user is usually required or supplied with a standard material having several fragment ions covering the mass spectral m/z range of interest. Subject to baseline effects, isotope interferences, mass resolution, and resolution dependence on mass, peak positions of a few ion fragments are determined either in terms of centroids or peak maxima through a low order polynomial fit at the peak top. These peak positions are then fit to the known peak positions for these ions through either 1^{st} or other higher order polynomial fit to calibrate the mass (m/z) axis.

After the mass axis calibration, a typical mass spectral data trace is subjected to peak analysis where peaks (ions) are identified. This peak detection routine is a highly empirical and compounded process where peak shoulders, noise in data trace, baselines due to chemical backgrounds or contamination, isotope peak interferences, etc., are considered.

For the peaks identified, a process called centroiding is typically applied where an attempt at calculating the integrated peak areas and peak positions would be made. Due to the many interfering factors outlined above and the intrinsic difficulties in determining peak areas in the presence of other peaks and/or baselines, this is a process plagued by many adjustable parameters that can make an isotope peak appear or disappear with no objective measures of the centroiding quality.

There are several notable disadvantages with this processing technique which has adverse impact on the quantitative and qualitative performance of mass spectral analysis:
Lack of Mass Accuracy. The mass calibration currently in use usually does not provide better than 0.1 amu (m/z unit) in mass determination accuracy on a conventional MS system with unit mass resolution (ability to visualize the presence or absence of a significant isotope peak). In order to achieve higher mass accuracy and reduce ambiguity in molecular fingerprinting such as peptide mapping for protein identification, one has to switch to an MS system with higher resolution such as quadrupole TOF (qTOF) or FT ICR MS which come at significantly higher cost.
Large Peak Integration Error. Due to the contribution of mass spectral peak shape, its variability, the isotope peaks, the baseline and other background signals, and random noise, current peak area integration has large errors (both systematic and random errors) for either strong or weak mass spectral peaks.
Difficulties with Isotope Peaks. Current approaches do not have a good way to separate the contributions from various isotopes which usually havepartially overlapped mass spectral peaks on conventional MS systems with unit mass resolution. The empirical approaches used either ignore the contributions from neighboring isotope peaks or over-estimate them, resulting in errors for dominating isotope peaks and large biases for weak isotope peaks or even complete ignorance of the weaker peaks. When ions of multiple charges are concerned, the situation becomes worse even, due to the now reduced separation in mass unit between neighboring isotope peaks.
Nonlinear Operation. The current approaches use a multi-stage disjointed process with many empirically adjustable parameters during each stage. Systematic errors (biases) are generated at each stage and propagated down to the later stages in an uncontrolled, unpredictable, and nonlinear manner, making it impossible for the algorithms to report meanly statistics as measures of data processing quality and reliability.
Dominating Systematic Errors. In most MS applications, ranging from industrial process control and environmental monitoring to protein identification or biomarker discovery, instrument sensitivity or detection limit has always been a focus and great efforts have been made in many instrument systems to minimize measurement error or noise contribution in the signal. Unfortunately, the peak processing approaches currently in use create a source of systematic error even larger than the random noise in the raw data, thus becoming the limiting factor in instrument sensitivity.
Mathematically and Statistically Inconsistency. The many empirical approaches used currently make the entire mass spectral peak processing inconsistent either mathematically or statistically. The peak processing results can change dramatically on slightly different data without any random noise, or on the same synthetic data with slightly different noise. In order words, the results of the peak processing are not robust and can be unstable depending on the particular experiment or data collection.
Instrument-To-Instrument Variations. It has usually been difficult to directly compare raw mass spectral data from different MS instruments due to variations in the mechanical, electromagnetic, or environmental tolerances. The current ad hoc peak processing applied to the raw data, only adds to the difficulty of quantitatively comparing results from different MS instruments. On the other hand, the need for comparing either raw mass spectral data directly or peak processing results from different instruments or different types of instruments has been increasingly important for the purposes of impurity detection or protein identification through searches in established MS libraries.
   Extracting Ion Chromatograms from Mass Spectral Data

Due to the large mass errors caused by the mass spectral processing approaches discussed above, when multiple mass spectral scans from a time dependent measurement such as GC/MS or LC/MS experiments need to be combined to create a chromatogram, one typically has to open a large mass window to integrate the ion intensities and plot them as a function of time to generate a chromatogram called extracted ion chromatogram (XIC). For example, Liquid chromatography interfaced with (tandem) mass spectrometry (LC/MS or LC/MS/MS) has been widely utilized for obtaining structural information of molecules such as the sequence of proteins and metabolic pathways of pharmaceuticals. As mentioned to above, to study a drug and its metabolites, the drug is typically injected into an animal model and biological fluids are taken from the animal model as samples for subsequent sample preparation such as extraction and LC/MS analysis. The drug and its metabolites are separated in time and then detected with mass spectrometry. To search for a particular molecule, either the drug itself or its possible metabolites, the user would go through a post-analysis process to extract ion chromatograms in a large enough m/z window so as not to miss the ion of interest due to the lack of mass accuracy and mass errors introduced by existing mass spectral centroiding process. For verapamil (C₂₇H₃₉N₂O₄⁺, monoisotopic mass 455.2910Da), for example, the drug itself will typically be seen in an extracted ion chromatogram in the m/z range of 454.8 and 455.8. This approach suffers from several drawbacks:
1. On conventional unit mass resolution systems, the mass spectral centroiding process can rarely provide better than 0.1 Da in mass accuracy, necessitating ion integration in a large mass window such as +/−0.5 Da.
2. While such large mass window has the potential advantages of getting more ions integrated with better signal-to-noise, it at the same time opens up the window for unwanted ions from background and matrices, complicating the extracted ion chromatogram and its interpretation.
3. Even with such a large mass window, not all ion signals are used to create the XIC and achieve the highest possible signal to noise as signals from other isotope clusters of the same ion, such as M+1, are completely ignored.
4. Even on higher resolution MS systems where one could afford to narrow the integration window due to the narrower peak width and higher mass accuracy achievable, such ion extraction process is prone to errors caused by including the isotope ions of other ions. In the above example, the M+1 isotope cluster from another ion at 454.291 Da will show up in the m/z window of verapamil and be included as the ion of interest.

Due to these complications, LC/MS data processing and interpretation typically takes longer than the LC/MS experiment itself, in spite of an apparently complicated multi-step process involved in acquiring the data through sample preparation, LC separation and MS analysis. The presence of biological matrices such as bile, feces and urine further complicates the analysis due to the many background ions these matrices generate. There are currently two approaches to address the issue of complex matrices:
1. Use a higher resolution system such as qTOF or even FTMS where the higher resolution and better mass accuracy can lead to better separation and differentiation between the ions of interest and those coming from the background matrices, allowing for ion chromatograms to be generated in a tighter and more selective mass window.
2. Perform further MS analysis through MS/MS experiments that offer a variety of structurally specific information to facilitate identification of metabolites and proteins/peptides in the presence of biological matrices.

Recent prior art (Journal of Mass Spectrometry, Volume 38, Issue 10, Date: October 2003, Pages: 1110-1112; and United States Patent Publication No. 2005/0272168 A1) takes advantage of the similar mass defects between a parent compound and its transformed products such as metabolites and proposes a different approach for ion chromatogram extraction based on a narrow mass defect window of, for example, +/−50 mDa, through the use of high resolution mass spectrometer.

### SUMMARY OF THE INVENTION

It is an object of the invention to provide a method for calibrating chromatograms, plasmagrams, or other time-dependent signal to achieve peak shape correction, noise filtering, peak detection, retention time or mobility determination, baseline correction, and peak area integration.

It is another object of the invention to provide for quantitative or qualitative analysis using profile mode mass spectral data, acquired through either full mass spectral scanning mode or Selective Ion Monitoring (SIM) mode.

It is also an object of the invention to provide a method for extracting ion chromatogram from LC/MS or GC/MS runs with high mass accuracy to achieve interference and background ion removal for better and unbiased chromatographic quantitation and molecular identification such as metabolite identification based on mass defects, even on conventional mass spectrometers of approximately unit mass resolution, with mass spectral Full Width at Half Maximum (FWHM) approximately 0.3 Da or larger.

It is yet another object of the invention to provide a means to standardize and align retention time axes based on extracted accurate mass ion chromatograms for common ions from multiple GC/MS or LC/MS runs so that many runs of GC/MS or LC/MS data can be quantitatively compared and directly analyzed as a stack of matrices.

It is a further object of the invention to provide apparatus operating in accordance with these methods.

It is still another object of the invention to provide computer readable media, having computer readable program instructions thereon, which when executed on a computer associated with one of such apparatus will perform the described methods.

The chromatographic data analysis of the present invention includes a novel approach for calibrating chromatograms, plasmagrams, or other time-dependent signals to achieve peak shape correction, noise filtering, peak detection, retention time or mobility determination, baseline correction, and peak area integration. While the description will focus on LC/MS/MS quantitation (FIG. 1 which includes Ion Mobility Spectrometry or IMS), the same approach applies to other hardware systems involving single or multiple separation systems with a single- or multi-channel detector, such as LC/UV, LC/RAM (Radio-Activity Monitor), GC/MS, MS (Ion Mobility Spectrometry), and LC/RI (Refractive Index), as shown in FIG. 2 and FIG. 3. Cases with either external or internal standard(s) are covered.

The mass spectral data analysis of the present invention includes a novel approach to perform quantitative or qualitative analysis using profile mode mass spectral data, acquired through either full mass spectral scanning mode (as is more available for TOF-MS or FT-MS systems) or Selective Ion Monitoring (SIM) mode (as is more available on quadrupole MS systems), covering:

A. Cases where the unknowns to be quantified have already been identified with given molecular formula and where they have not been identified;

B. Cases involving at least one internal standard; and

C. Cases not involving any internal standard.

The method to extract simplified or accurate mass ion chromatogram has these key aspects:

1. Ion chromatograms can be extracted accurately and precisely in a tiny mass window from even conventional low resolution mass spectrometer systems due to the comprehensive mass spectral calibration available, enabling rapid drug metabolite identification based on either accurate mass or mass defect filtering on systems having approximately unit mass resolution.

2. The extracted accurate mass ion chromatograms from common ions such as the parent drug, its metabolites, the background, or added standard ions can be utilized as the basis for full chromatographic calibration to correct for chromatographic peak shape variations and retention time shifts from one LC/MS run to another, enabling direct and quantitative comparison of multiple LCI-MS runs. The same applies to GC/MS.

Thus, the invention is directed to a method for processing a chromatogram, comprising obtaining at least one actual chromatographic peak shape function from one of an internal standard, an external standard, or an analyte represented in the chromatogram; performing chromatographic peak detection using known peak shape functions with regression analysis; reporting regression coefficients from the regression analysis as one of peak area and peak location; and constructing a calibration curve to relate peak area to known concentrations in a calibration series. The chromatogram can be a time-dependent signal representing the arrival and disappearance of an analyte. The time-dependent signal can include one of a chromatogram derived from LC/MS/MS and a plasmagram from an ion mobility spectrometer.

The method can further comprise defining a target chromatogram mathematically; and converting the actual chromatogram into the target chromatogram. The known peak shape function can be one of actual chromatographic peak shape function or target peak shape function.

The method can further comprise calibrating the chromatogram by specifying at least one target chromatographic peak shape function; obtaining a calibration filter; and applying the calibration filter to transform a measured chromatogram into a calibrated chromatogram. The method can further comprising performing multivariate statistical analysis on the calibrated chromatogram to achieve at least one of identification, classification, and quantification. The method can further comprise using multiple standards across a retention time range of interest; and obtaining a calibration filter for a plurality of retention times within the time range.

The method can further comprising transforming an x axis of a measured chromatogram to normalize the peak shape function. The calibration filter can be obtained by performing a deconvulution operation. The deconvolution operation can comprise one of a matrix operation or a Fourier transform. The peak areas can be first ratioed to those of the internal standards, prior to constructing the calibration curve. The method can further comprise using the calibration curve to calculate unknown concentration of an analyte. The method can further comprise using the peak detection to produce at least one of time measurements and standardized mobility for qualitative analysis. The actual chromatographic peak shape function can be one of actually measured or numerically derived from partially overlapping chromatographic peaks. The partially overlapping chromatographic peaks are from chiral compounds.

The invention is also directed to an analytical instrument operating in accordance with the methods described above, as well as to a computer readable medium having computer code thereon for performing the methods, the code being for use by a computer operating with an analytical instrument.

In accordance with another aspect, the invention is directed to a method for processing a mass spectrum comprising calibrating the mass spectrum for at least one of mass and peak shape; constructing a peak component matrix; performing a regression between the mass spectrum and the peak component matrix; reporting at least one regression coefficient as related to the concentration of an ion; and using the reported regression coefficients from a plurality of mass spectra for one of quantitative or qualitative analysis. The peak component matrix can contain at least one of linear and nonlinear baseline components. The peak component matrix can contain the isotope profile of at least one ion of interest. The ion of interest can be one of possible metabolites of a known drug. The isotope profile can be one of theoretically calculated based on elemental composition, and actually measured. The peak component matrix can contain the derivative of the isotope profile of at least one ion. The derivative can be one of theoretically calculated based on formula and equations, and numerically calculated based on being actually measured. The peak component matrix can contain the isotope profile of both the native and labeled ion linearly combined or each individually.

The method can further comprise constructing a calibration curve; and relating the at least one reported coefficient to actual concentration for the purpose of quantitative analysis. The regression can be performed on both an internal standard ion and an analyte ion and reported coefficients can be ratioed between the internal standard ion and the analyte ion prior to constructing the calibration curve. The method can further comprise plotting a reported coefficient related to an ion concentration against retention time to generate an extracted ion chromatogram. The method can further comprise reporting at least one of fitting residual and mass error from the regression analysis; and using at least one of said fitting residual and mass error to construct a weight function. In addition, the can comprise applying the weight function to the regression coefficient related to the ion concentration to reduce interferences from coexisting ions. The method can further comprise plotting the weighted regression coefficient against the retention time to generate an extracted ion chromatogram.

In accordance with yet another aspect, the invention is directed to a method for constructing an extracted ion chromatogram, comprising calibrating a low resolution mass spectrometer for both mass and peak shape in profile mode; performing mass spectral peak analysis and reporting both mass locations and integrated peak areas; specifying a mass defect window of interest; summing up all detected peaks with mass defects falling within the specified mass defect window to derive summed intensities; and plotting the summed intensities against time to generate a mass defect filtered chromatogram. The mass spectral peak analysis can be performed by a fast algorithm including a simple function. The simple function can be a quadratic function. The mass defect window is preferably within a small mass defect range that includes the mass defect of a drug of interest. The method can further comprise subjecting the detected peaks to a threshold based on at least one of mass error, peak area error, and peak area magnitude, before said intensities are summed.

The invention is also directed to an analytical instrument, including a mass spectrometer, operating in accordance with the methods, as well as a computer readable medium having computer code thereon for performing the methods, the code being for use by a computer operating with an analytical instrument including a mass spectrometer.

Each of these areas and respective aspects will be described below along with some results to demonstrate their utilities.

### BRIEF DESCRIPTION OF THE DRAWINGS

The foregoing aspects and other features of the present invention are explained in the following description, taken in connection with the accompanying drawings, wherein:

FIG. 1 is a block diagram of an analysis system in accordance with the invention, including a mass spectrometer or ion mobility spectrometer (IMS), and optionally a front end separation process such as an LC system.

FIG. 2 is a block diagram of a system having one dimensional sample separation, and a single- or multi-channel detector, wherein separation may be based on ion mobility in the case of IMS.

FIG. 3 is a block diagram of a system having two or more dimensional sample separation, and a single- or multi-channel detector, wherein separation may be based on ion mobility in the case of IMS.

FIG. 4A and FIG. 4B are graphs illustrating the chromatographic calibration process, wherein FIG. 4A is an actual chromatogram; FIG. 4B is a target chromatogram; and

FIG. 4C is a chromatographic calibration filter.

FIG. 5A and FIG. 5B are graphs illustrating applying chromatographic calibration near the detection limit wherein FIG. 5A is an actual chromatogram; and FIG. 5D is a calibrated chromatogram.

FIG. 6A and FIG. 6B are graphs illustrating a typical LC/MS/MS calibration series, herein FIG. 6A includes the calibrated chromatograms from the calibration series; and FIG. 6B illustrates the calibration curve.

FIG. 7A1, FIG. 7A2, FIG. 7B1 and FIG. 7B2 are graphs illustrating metabolite identification using accurate mass and mass defects from a low resolution mass spectrometry system, wherein FIG. 7A1: is a complex total ion chromatogram (TIC),

FIG. 7A2 is a buspirone mass spectrum; FIG. 7B1 is a clean accurate mass defect ion chromatogram, and FIG. 7B2 illustrates the mass spectrum of a possible metabolite.

FIGS. 8A to 8D includes graphs illustrating verapamil incubation with bile as matrix, wherein FIG. 8A is a total ion chromatogram; FIG. 8B is an extracted ion chromatogram between 440.8 and 441.8 Da; FIG. 8C is a filtered chromatogram showing four different demethylation metabolites; and FIG. 8D illustrates a confirmation of a demethylation metabolite by accurate mass measurement.

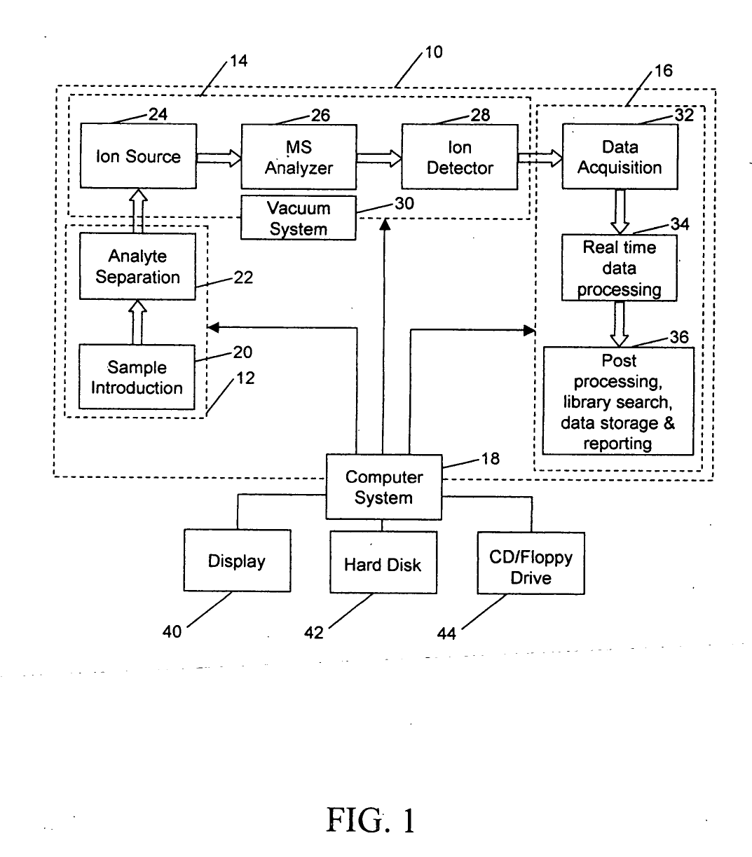

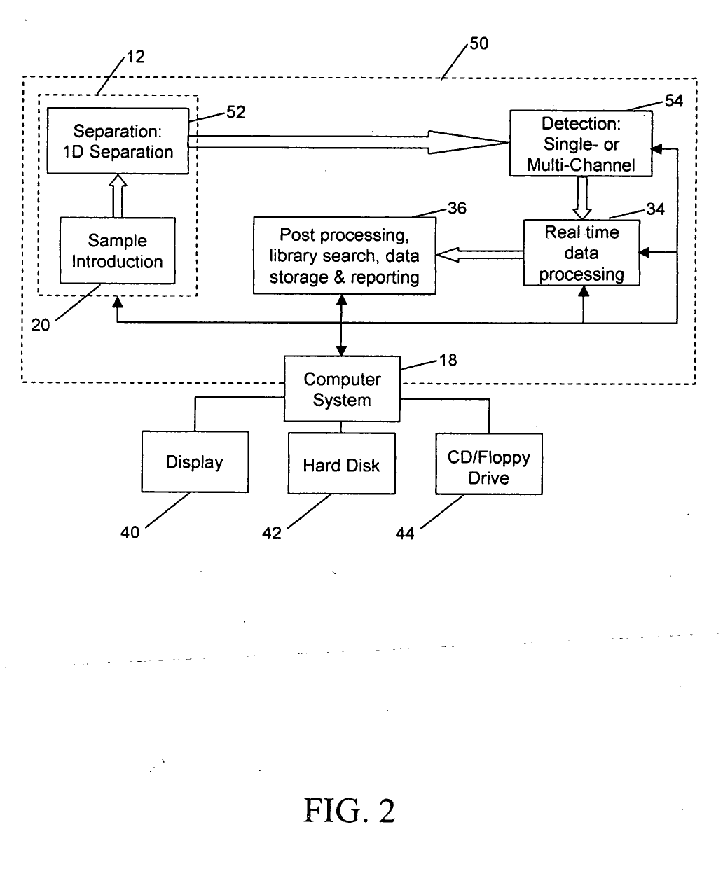

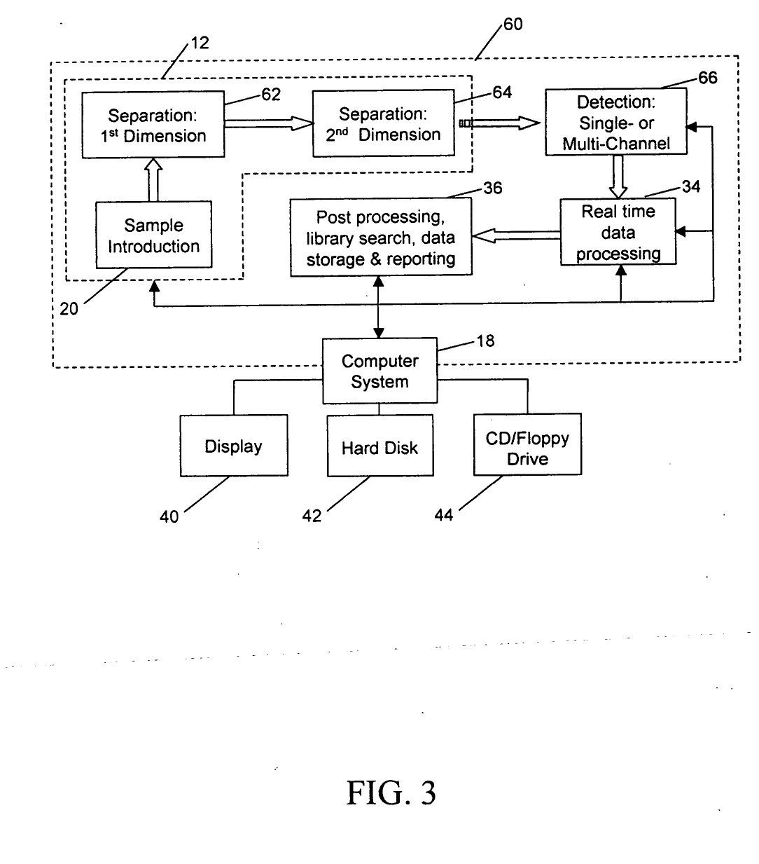

### DETAILED DESCRIPTION OF THE PREFERRED EMBODIMENTS

As pointed out in an earlier filing, U.S. Pat. No. 6,983,213, and International Patent Application PCT/US2004/034618 filed on Oct. 20, 2004, the chromatograms obtained in terms of detected signal as a function of time may be calibrated through the use of a calibration filter. The following description uses a chromatogram as an example, but the approach applies to other time-dependent signals such as plasmagrams produced by IMS. The steps needed in creating a calibration filter include:

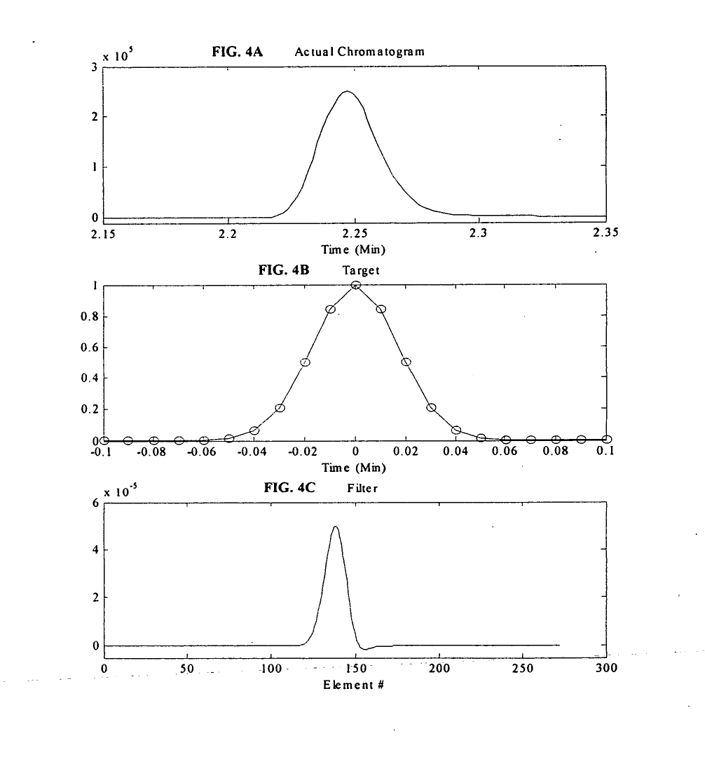

1. Obtain an actual chromatographic peak (FIG. 4A) in one of the following ways:
A. In a separate chromatographic run under nominally the same conditions, for example, the same unknown at higher concentration levels in a calibration series to allow for good signal-to-noise measurement of the peak shape function.
B. In the same chromatographic run with the use of a separate but parallel detector, such as a RAM (Radioactivity Monitor—usually used for radio-labeled compounds) in tandem with MS detection.
C. In the same, or a separate, chromatographic run with the use of an internal standard through the same or different detector, such as MRM or SRM in LC/MS/MS experiments.
D. Mathematically or numerically derived chromatographic peak shapes from overlapped chromatograms of difficult-to-separate compounds such as chirals.

2. Define a target chromatographic peak mathematically to convert this actual chromatogram into the target chromatogram with the following preferred properties:
A. A physically desirable peak shape such as peak symmetry (without tailing, for example). Peak symmetry is preferred as it results in computationally efficient cyclic matrices in subsequent peak detection and analysis.
B. A computationally efficient and statistically preferred functional form such as a Gaussian which is continuously differentiable analytically with minimized error propagation in subsequent peak detection and analysis due to the orthogonality of all its derivatives.
C. A target peak shape that resembles the actual measured chromatographic peak shape.
D. A target peak shape width (FWHM) slightly wider than the actual peak width to allow for reliable calibration.

The target peak shape function is centered within the retention time range of interest (FIG. 4B) or a theoretically calculated mobility at a standard temperature and pressure in the case of a plasmagram for IMS.

3. Perform a deconvolution operation through either matrix operation or Fourier transform to calculate a calibration filter that, when applied to the actual chromatographic data, will convert the actual chromatographic peak shape function into the physically desirable and mathematically definable target peak shape function. FIG. 4C shows such a chroinafographic calibration filter. Step 2 and 3 can optionally be performed in a transformed x-axis to essentially normalize peak shape functions across the x-axis range of interest.

4. When multiple standards are available across a retention time range of interest, multiple calibration filters can be obtained at corresponding retention time points.

When properly interpolated through wavelet or singular value decomposition or other linear/nonlinear interpolation, a calibration filter for each retention time point can be obtained.

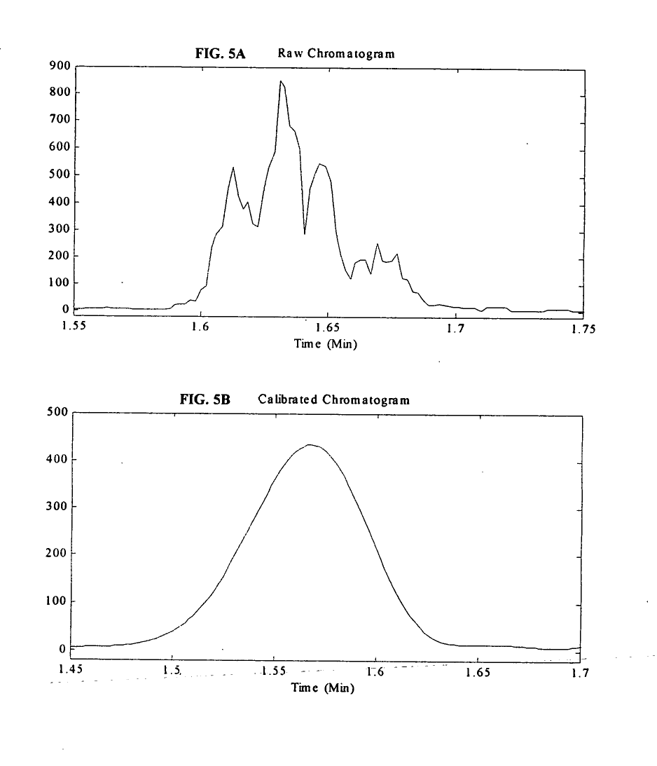

5. Either a universal calibration filter from step 3 or a retention-time-specific filter from step 4 can then be applied to an actual chromatogram to arrive at a calibrated chromatogram. FIGS. 5A and 5B show a chromatogram before (FIG. 5A) and after (FIG. 5B) the calibration for an analyte near the detection limit.

6. Perform multivariate statistical analysis such as cluster analysis and discriminant analysis on the calibrated chromatogram to achieve one of identification, classification, and quantification of the samples, serially or in parallel.

7. Perform peak detection and analysis on the calibrated chromatogram through the use of a weighted regression analysis and the now known target peak shape function, and report the fitting parameters or coefficients as outputs for quantitative (integrated peak area, for example) and/or qualitative (retention time or ion mobility, for example) analysis (identification of ions or molecules). The baseline contribution is automatically calculated and compensated for in this least squares fitting process by supplying the necessary baseline components.

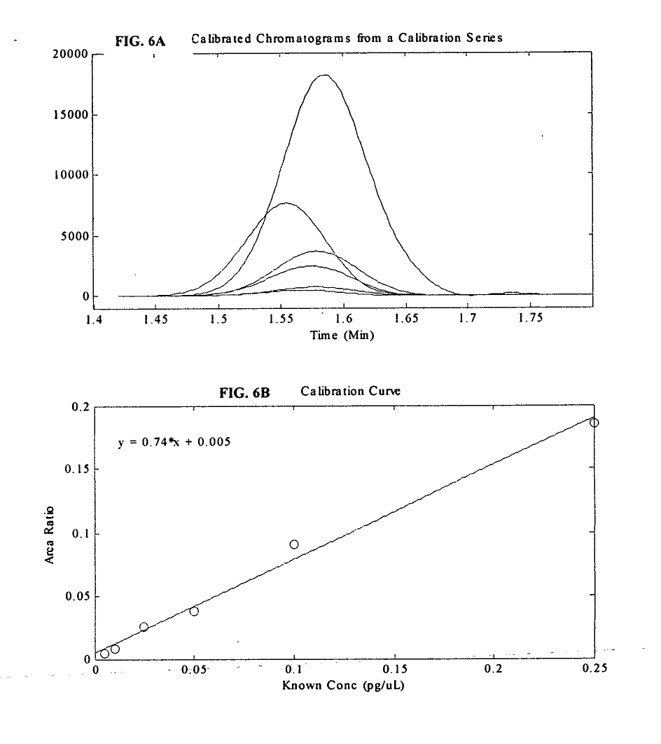

8. The integrated peak areas from the analyte of interest at multiple known concentration levels from a calibration series (FIG. 6A) can now be regressed against the known concentrations to obtain a calibration curve (FIG. 6B) that relates the measured peak areas to analyte concentrations.

9. With the presence of an internal standard, a same or separate chromatographic calibration process maybe applied to give corresponding peak areas for the internal standards. These internal standard peak areas can be applied to the peak areas of the analyte to obtain normalized peak areas or peak area ratios with respect to the internal standard peak areas. These area ratios are advantageously used for the establishment of a calibration curve, given that the internal standard typically tracks the variations among different runs due to the changes in sample preparation, ionization, or detectors. As an alternative, a different calibration can be derived for each run based on the internal standard alone, which can then be applied to calibrate both the internal standard peak and the analyte peak, with the added benefits of correcting for the chromatographic retention time shift from one run to another, and better facilitating the peak detection.

10. Once the calibration curve is established, one may proceed with the analysis of an unknown sample by acquiring the raw chromatogram for the analyte of interest with the option of an internal standard, applying the chromagraphic calibration just developed from the calibration series above or the chromatographic run itself, performing peak detection and analysis to arrive at either integrated peak areas or area ratios, and using the calibration curve to calculate the unknown concentration. The peak detection can also produce highly accurate time measurements such as calibrated retention times or standardized mobility for qualitative analysis, such as the detection of particular compounds (such as, for example, explosives).

The above steps can help achieve these important benefits over other approaches currently under use:

I. Transform actual peak shape including peak tailing into the mathematically definable target peak shape function without tailing.

II. Achieve accurate retention time or standardized mobility measurement for high fidelity compound identification.

III. Align the retention time axes from multiple runs accurately for direct quantitative comparisons of multiple data sets.

IV. Achieve noise filtering at the low end of quantitation and improve detection or quantitation limit.

V. Allow for parameter-free chromatographic peak detection and analysis including automatic baseline removal.

VI. Eliminate bias and minimize noise contribution in peak area integration at all concentration levels, allowing for better quantitative accuracy and precision through a more accurate and precise calibration curve. More than a factor of 2-3 reduction in quantitative error and coefficient of variation (CV%) is observed.

VII. Achieve fully automated quantitative analysis and eliminate the time consuming and error prone human review.

After the above step 1, one could bypass steps 2-6 and proceed directly to step 7 for peak detection and analysis. In this case, the actual (typically asymmetrical) peak shape function will be used instead of the target peak shape function and the raw chromatogram (without the calibration) will be directly used in a weighted regression for peak detection and analysis. Not all, but part of the above listed benefits are realized through this latter approach, including parameter-free peak detection and analysis, improved detection limit, and more accurate and precise quantitative results.

The weights in the above mentioned weighted regression, are statistically defined as proportional to the inverse of the variance at each point on the chromatogram, or the inverse of the ion signal at each time point in a well designed instrument where the noise on the measured signal is dominated by the ion counting noise. When the weights are not available, weights all having values equal to one will be used across a chromatogram, i.e., as if no weights are applied.

Quantitative and Qualitative Analysis Using Profile Mode MS Data

Depending on the nature of mass spectrometer used, the mass spectral quantitation may be carried out with or without generating a-mass spectral profile in either a full or a limited mass spectral range. In quadrupole MS, for example, due to the sequential scanning mechanism involved, it is typically advantageous to measure only the most intense ions within the mass window in order to achieve the highest signal to noise ratio. In this case, the minor isotopes such as M+1 or above are typically ignored due to their much lower intensities and the measurement time is typically better spent by allowing the quadrupole to accumulate data from the major isotope during the entire measurement time. In other types of MS systems such as FTMS or TOF-MS, however, there is no time penalty in measuring all the ions including the isotopes from M+1 and above, as the instrument is always operating in full MS scanning mode.

When profile mode MS data containing isotopes are available for quantitative MS analysis, a novel approach can be taken to achieve the following advantages:
1. Unbiased quantitative results or higher accuracy;
2. Minimized noise propagation into the quantitative results or higher precision or lower coefficients of variation (CV%);
3. Automated baseline compensation;
4. Fully automated peak detection and peak area integration; and
5. Lower Limit Of Quantitation (LOQ).

The basic model for when mass spectral profile mode data are available is given by:
r=Kc+e

where r is an (n×1) matrix of the profile mode mass spectral data measured of the sample; c is a (p×1) matrix of regression coefficients which are representative of the concentrations of p components in a sample; K is an (n×p) matrix composed of profile mode mass spectral responses for the p components, all sampled at n mass points; and e is an (n×1) matrix of a fitting residual with contributions from random noise and any systematic deviations from this model.

The components arranged in the columns of matrix K will be referred to as peak components, which may optionally include any baseline of known functionality such as a column of 1's for a flat baseline or an arithmetic series for a sloping baseline. A key peak component in matrix K is the known mass spectral response for the analyte of interest, which can either be experimentally measured or theoretically calculated.

When the analyte of interest has been identified with its molecular formula known, it is preferred that the peak component in matrix K be calculated as the convolution of the theoretical isotope distribution and the known mass spectral peak shape function. This known mass spectral peak shape function may be directly measured from a section of the mass spectral data, mathematically calculated from actual measurements through deconvolution, or given by the target peak shape function if a comprehensive mass spectral calibration has already been applied, all using the approach outlined in U.S. Pat. No. 6,983,213 and International Patent Application PCT/US04/034618 filed on Oct. 20, 2004.

When the analyte of interest has not been identified (has an unknown molecular formula), actual measured profile mode MS data may be used as a peak component in K. This actual measured profile mode MS data is typically available as part of a calibration series where different concentration levels of the analyte are measured in order to establish a calibration curve. The measured profile data from a higher concentration level is typically preferred for its enhanced signal-to-noise. Alternatively, the mass spectral response at the apex during a chromatographic peak elution can also serve as the peak component. It should be noted that there is no need to perform any baseline correction on this peak component as any difference in baseline between this peak component and a sample measurement in r to be fitted will be fully compensated for by the baseline components also included in K.

In the case of drug metabolism studies involving a mixture of the native compound and its radio-labeled counterpart, either a single peak component comprised of a given linear combination of the corresponding isotope clusters (either calculated or measured) or multiplepeak components corresponding to individual isotope clusters may be included in the peak component matrix K.

Optionally, one or more first derivatives corresponding to that of a peak component, a known linear combination of several peak components, or the measured mass spectral data r may be added into the peak components matrix K to account for any mass spectral errors in r.

Once proper peak components matrices are arranged into the matrix K, including any known interfering ions and labeled isotopes if applicable, the model above can be solved for concentration vector c with given mass spectral response r, in a least squares regression process. The concentration vector c contains the concentration information of all included peak components including any baseline contribution automatically determined. For derivatives included, the corresponding coefficients in concentration vector c contains the mass error information for the given components included in peak component matrix.

For most mass spectrometry applications where the noise in the mass spectral response r typically comes from ion shot noise, it is advantageous to use weighted regression in the above model where the weight at each mass sampling point would be inversely proportional to the signal variance at this mass spectral sampling point, i.e., the mass spectral intensity itself

Each element in the concentration vector c obtained above is proportional to the true contribution from the corresponding peak component, eliminating the need for elaborate and mostly heuristic manual baseline removal, as well as the difficulty in peak area integration with the presence of peak asymmetry and interferences from isotopes and other ions.

For each standard sample in a calibration series, a concentration scalar in c is obtained corresponding to the analyte peak component. This concentration scalar from each standard can then be regressed against the true known concentration to form a standard or calibration curve, thus establishing the relationship between the calculated concentration scalar and the true concentration.

For an unknown sample with its measured mass spectral response r, the model above can be solved to give its corresponding concentration scalar, which can then be converted into measured concentration using the calibration curve established above, accomplishing the task of quantitative analysis.

In the presence of an internal standard coexisting with the analyte of interest, a different but similar mathematical model can be constructed for the internal standard. The concentration scalar for the internal standard in each sample can be solved in much the same way as the analyte to provide a normalization factor for the analyte concentration scalar prior to standard curve regression or unknown concentration lookup. Though the identity and molecular formula of the internal standard are almost always known, which enables a theoretical solution for the internal standard peak component, actual measured mass spectral response from any sample serves the purpose also, provided there are no other interferences which may need to be accounted for explicitly in peak component matrix K. It should be noted that, with this approach, the analyte peak component and the internal standard peak component will be allowed to overlap without biasing the analytical results as long as they are included in the peak component matrix K. This works well for internal standards that are isotope labeled version of the analyte without complete mass spectral separation between the corresponding isotope clusters. Furthermore, more than one analyte and/or internal standards can be allowed into the peak component matrix K, to allow for simultaneous quantitation of multiple analytes with multiple internal standards.

When the objective is to create ion chromatograms by integrating mass spectral responses on an ion-by-ion basis, as is the case for many GC/MS or LC/MS applications, this approach can be applied to all ions in each mass spectral scan to produce ion intensity as a function of time, resulting in extracted ion chromatograms that integrate all isotopes of an ion (for better signal) without the painstaking step of peak definition or baseline/background correction. The least squares fitting of the above model also automatically provides signal averaging and noise filtering, resulting in even higher usable signal to noise for the analysis. In the presence of co-eluting ions that also overlap with the isotope cluster of the ion of interest without being accounted for in the peak component matrix K, however, the extracted ion chromatogram thus generated will be biased towards the high end (overestimation). Such a bias will be manifested through either a large fitting residual e or large mass error (with the use of derivatives in the peak component matrix K) or both. A weighting function defined to decrease with the increase in either e or mass error or both can be applied to the extracted ion chromatogram to correct for the overestimation and form an Accurate Mass and (isotope) Profile filtered eXtracted Ion Chromatogram (AMPXIC) for the ion of interest. In an LC/MS metabolism study, based on the parent drug of interest, one can proceed by proposing a list of possible biotransformtions, which typically does not exceed 100, and create an AMPXIC for each of the possible metabolites by performing the fitting process outlined above in a small relevant mass range, to facilitate rapid metabolite screening or identification.

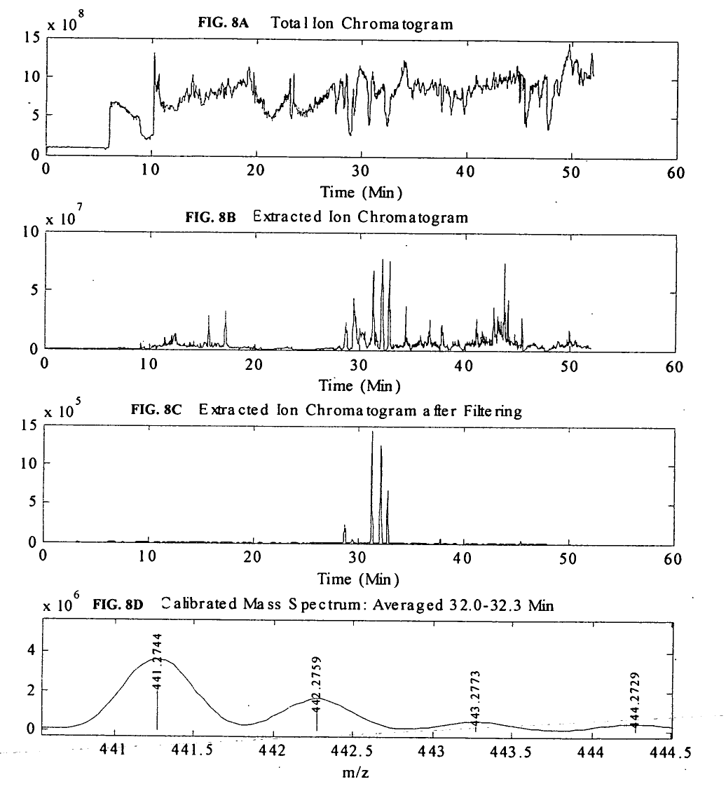

FIG. 8A shows the total ion chromatogram of the Verapamil drug and its incubation metabolites in a bile matrix. It is a very complex pattern of peaks and matrix ions and there is no clearly discernable metabolite information. FIG. 8B shows a conventional extracted ion chromatogram in the mass window between 440.8 and 441.8 Da, which still contains a rather complicated set of peaks throughout the 1-hour run, confirming the challenges faced by conventional ion chromatogram extraction at unit mass resolution. FIG. 8C shows the filtered chromatogram calculated using the novel approach disclosed here, with only a few clearly identifiable peaks corresponding to different demethylation metabolites of the Verapamil drug, which is further confirmed by the accurate mass measurement on the corresponding mass spectral data (measured 441.2744 vs true 441.2753 Da, in FIG. 8D).

The ion chromatograms thus obtained, including an accurate mass ion chromatogram, a mass defect filtered ion chromatogram, or an AMPXIC, can be further processed using the approach presented in the previous section for quantitative analysis through the optional chromatographic calibration and the subsequent peak detection and analysis.

The mass spectral response r in the above equation can also come from the combined mass spectrum as the sum or average of many individual MS scans in a given retention time window, a feature available on many commercial GC/MS or LC/MS systems.

Filtering Ion Chromatograms to Reduce or Eliminate Interferences

There are several steps involved in creating an accurate mass ion chromatogram, which have only been available on high resolution MS systems such as qTOF, TOF-TOF, or FTMS. With the use of comprehensive mass spectral calibration, however, this capability can be achieved on a conventional unit mass resolution or low resolution mass system. The accurate mass ion chromatogram, also enables full calibration for the time domain—correcting for both the chromatographic peak shapes and retention time shift, all in one operation using the information even from the LC/MS or GC/MS data runs themselves. The key steps include:

1. Perform the comprehensive mass spectral calibration as outlined in U.S. Pat. No. 6,983,213 and International Patent PCT/US2004/034618 filed on Oct. 20, 2004 on each MS scan during an LC/MS run, based on external and/or internal calibration.

2. The raw MS scan after this comprehensive calibration will enable mass spectral peak detection and analysis with high mass accuracy for all peaks in each scan. The mass error corresponding to the detected peaks can typically be controlled to within 5-10 mDa, i.e., 0.005-0.010 Da, even on a unit mass resolution MS system.

3. Ion chromatograms can now be extracted in a very tiny mass window of 0.005-0.010 Da, for example, over the -retention time range- of interest, largely eliminating the contributions from interfering background or matrix ions. With the accurate mass available, a drug and its metabolites can now be easily identified based on the similar mass defects between a drug and its corresponding metabolites (Journal of Mass Spectrometry, Volume 38, Issue 10, Date: October 2003, Pages: 1110-1112; and United States Patent Publication No. 2005/0272168 A1), even using a low resolution mass spectrometer, a technique not previously thought to be possible. Ion chromatograms with mass defects falling within a small window, for example, +/−0.050Da, can be summed up to create a composite ion chromatogram containing both the drug and all its metabolites but essentially without the interference from other coexisting background or interfering ions. This greatly facilitates the rapid metabolite screening and identification in pharmaceutical research. It should be pointed out that such use of mass defect filtering requires a complete GC/MS or LC/MS run with typically several thousand MS scans to be peak analyzed at high mass accuracy. Due to the comprehensive mass spectral calibration performed, which transforms the actual MS peak shape into a symmetrical peak shape function, a much faster peak analysis algorithm can be adopted to fit any simple symmetrical function, such as a quadratic curve, to the top portion of the calibrated MS peak to determine the peak apex accurately enough for mass defect filtering. Furthermore, in the presence of many weak background ions or chemical noise whose apparent masses fluctuate throughout the mass range and the chromatographic run, mass defect filtering tends to include these ions which may overwhelm the few ions from the parent drug and its metabolites. It is therefore necessary to establish a threshold based on either ion intensity, intensity confidence interval, mass error bar, or some combination of these.

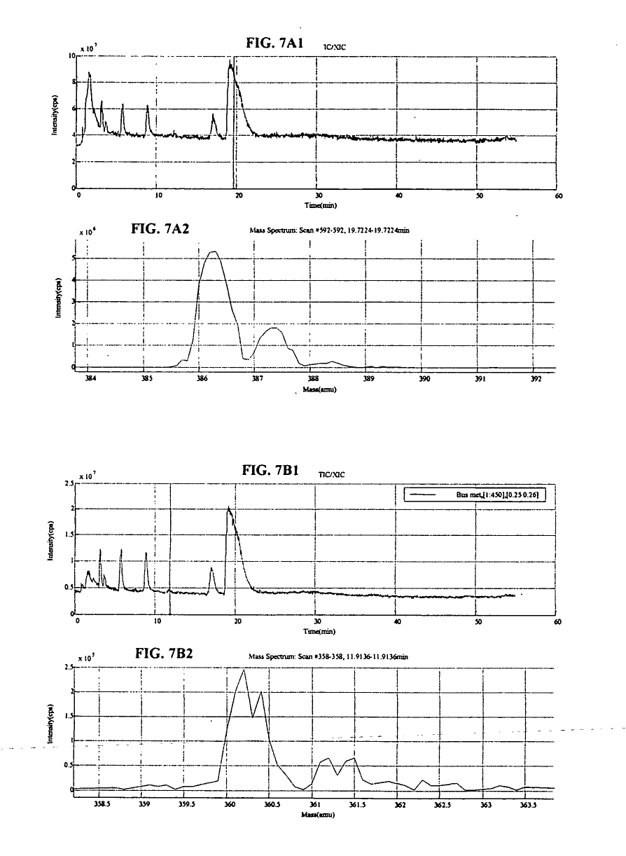

FIG. 7A1 and FIG. 7A2 show a complex total ion chromatogram (TIC) and an associated mass spectrum with too many chromatographic peaks whereas FIG. 7B1 and FIG. 7B2 show a clean accurate mass defect ion chromatogram and associated mass spectrum with only the drug (buspirone) and its metabolites, with the same 0.25-0.26 Da mass defects standing out as the major chromatographic peaks in the composite mass defect chromatogram.

4. The accurate mass ion chromatograms for common ions (from background, matrix, or added internal standards) existing in multiple LC/MS runs can now be used as standard chromatograms to develop a full chromatographic calibration to correct for both chromatographic peak shape and retention time shift, with the same approach outlined above for comprehensive chromatographic calibration. Alternatively, when signals from other tandem detectors are available, such as from a RAM coupled online and in parallel to the MS detector, one may use the RAM chromatograms as standard chromatograms to develop the full chromatographic calibration outside of MS.

5. The chromatographic calibration thus developed can be applied to each mass spectral sampling point (profile mode MS data) or to each accurate mass ion chromatogram (profile mode data after MS peak detection and analysis, a process also called centroiding, all with high mass accuracy) in the corresponding LC/MS run to standardize and align each corresponding retention time axis, allowing for direct and quantitative comparison of all LC/MS runs, when both the mass and retention time axis have been fully calibrated.

6. Most importantly, it is now possible to apply higher order data analysis approaches such as PARAFAC to analyze multiple LC/MS data sets as a stack of matrices and yield both quantitative and qualitative information in a single mathematical decomposition. These and other higher order methods have been outlined in U.S. Provisional patent applications 60/466,010, 60/466,011 and 60/466,012 all filed on Apr. 28, 2003, and International Patent Applications PCT/US2004/013096 and PCT/US2004/013097 both filed on Apr. 28, 2004.

The techniques described above may be used in a variety of instruments, and the embodiments of the invention are directed to such apparatus, as well as to a computer readable media having computer readable program instructions stored thereon, which when executed on a computer associated with one of such apparatus will perform the methods described herein.

Although the present invention has been described with reference to the embodiments shown in the drawings, it should be understood that the present invention can be embodied in many alternate forms of embodiments. In addition, any suitable type of elements or materials could be used. Thus, it should be understood that the foregoing description is only illustrative of the invention. Various alternatives and modifications can be devised by those skilled in the art without departing from the invention.

Accordingly, the present invention is intended to embrace all such alternatives, modifications and variances.

What is claimed is:

1. A method for processing a chromatogram, comprising:
obtaining at least one actual chromatographic peak shape finction from one of an internal standard, an external standard, or an analyte represented in the chromatogram;
performing chromatographic peak detection using known peak shape functions with regression analysis;
reporting regression coefficients from the regression analysis as one of peak area and peak location; and
constructing a calibration curve to relate peak area to known concentrations in a calibration series.

2. The method of claim 1, where the chromatogram is a time-dependent signal representing the arrival and disappearance of an analyte.

3. The method of claim 2, where the time-dependent signal includes one of a chromatogram derived from LC/MS/MS and a plasmagram from an ion mobility spectrometer.

4. The method of claim 1, further comprising:
defining a target chromatogram mathematically; and
converting the actual chromatogram into the target chromatogram.

5. The method of claim 1, where known peak shape function is one of actual chromatographic peak shape function or target peak shape function.

6. The method of claim 1, further comprising calibrating the chromatogram by:
specifying at least one target chromatographic peak shape function;
obtaining a calibration filter; and
applying the calibration filter to transform a measured chromatogram into a calibrated chromatogram.

7. The method of claim 6, further comprising performing multivariate statistical analysis on the calibrated chromatogram to achieve at least one of identification, classification, and quantification.

8. The method of claim 6, further comprising:
using multiple standards across a retention time range of interest; and
obtaining a calibration filter for a plurality of retention times within the time range.

9. The method of claim 6, further comprising transforming an x axis of a measured chromatogram to normalize the peak shape function.

10. The method of claim 6, wherein the calibration filter is obtained by performing a deconvulution operation.

11. The method of claim 10, wherein the deconvolution operation comprises one of a matrix operation or a Fourier transform.

12. The method of claim 1, wherein the peak areas are first ratioed to those of the internal standards, prior to constructing the calibration curve.

13. The method of claim 1, further comprising using the calibration curve to calculate unknown concentration of an analyte.

14. The method of claim 1, further comprising using the peak detection to produce at least one of time measurements and standardized mobility for qualitative analysis.

15. The method of claim 1, where the actual chromatographic peak shape function is one of actually measured or numerically derived from partially overlapping chromatographic peaks.

16. The method of claim 15, where the partially overlapping chromatographic peaks are from chiral compounds.

17. An analytical instrument operating in accordance with the method of claim 1.

18. A computer readable medium having computer code thereon for performing the method of claim 1, said code being for use by a computer operating with an analytical instrument.

19. A method for processing a mass spectrum comprising:
calibrating the mass spectrum for at least one of mass and peak shape;
constructing a peak component matrix;
performing a regression between the mass spectrum and the peak component matrix;
reporting at least one regression coefficient as related to the concentration of an ion; and
using the reported regression coefficients from a plurality of mass spectra for one of quantitative or qualitative analysis

20. The method of claim 19, wherein the peak component matrix contains at least one of linear and nonlinear baseline components.

21. The method of claim 19, wherein the peak-component matrix contains-the isotope profile of at least one ion of interest.

22. The method of claim 21, wherein the ion of interest is one of possible metabolites of a known drug.

23. The method of claim 21, where the isotope profile is one of theoretically calculated based on elemental composition, and actually measured

24. The method of claim 19, wherein the peak component matrix contains the derivative of the isotope profile of at least one ion.

25. The method of claim 24, wherein the derivative is one of theoretically calculated based on formula and equations, and numerically calculated based on being actually measured.

26. The method of claim 19, wherein the peak component matrix contains the isotope profile of both the native and labeled ion linearly combined or each individually.

27. The method of claim 19, further comprising:
constructing a calibration curve; and
relating the at least one reported coefficient to actual concentration for the purpose of quantitative analysis.

28. The method of claim 27, wherein the regression is performed on both an internal standard ion and an analyte ion and reported coefficients are ratioed between the internal standard ion and the analyte ion prior to constructing the calibration curve.

29. The method of claim 19, further comprising: plotting a reported coefficient related to an ion concentration against retention time to generate an extracted ion chromatogram.

30. The method of claim 19, further comprising:
reporting at least one of fitting residual and mass error from the regression analysis; and
using at least one of said fitting residual and mass error to construct a weight function.

31. The method of claim 30, further comprising applying the weight function to the regression coefficient related to the ion concentration to reduce interferences from coexisting ions.

32. The method of claim 31, further comprising plotting the weighted regression coefficient against the retention time to generate an extracted ion chromatogram.

33. An analytical instrument, including a mass spectrometer, operating in accordance with the method of claim 19.

34. A computer readable medium having computer code thereon for performing the method of claim 19, said code being for use by a computer operating with an analytical instrument including a mass spectrometer.

35. A method for constructing an extracted ion chromatogram, comprising:
calibrating a low resolution mass spectrometer for both mass and peak shape in profile mode;
performing mass spectral peak analysis and reporting both mass locations and integrated peak areas;
specifying a mass defect window of interest;
summing up all detected peaks with mass defects falling within the specified mass defect window to derive summed intensities; and
plotting the summed intensities against time to generate a mass defect filtered chromatogram.

36. The method of claim 35, wherein the mass spectral peak analysis is performed by a fast algorithm including a-simple function.

37. The method of claim 36, wherein the simple function is a quadratic function.

38. The method of claim 35, wherein the mass defect window is within a small mass defect range that includes the mass defect of a drug of interest.

39. The method of claim 35, further comprising subjecting the detected peaks to a threshold based on at least one of mass error, peak area error, and peak area magnitude, before said intensities are summed.

40. An analytical instrument, including a mass spectrometer, operating in accordance with the method of claim 35.

41. A computer readable medium having computer code thereon for performing the method of claim 35, said code being for use by a computer operating with an analytical instrument including a mass spectrometer.
